(19) United States
(12) Patent Application Publication
(10) Pub. No.: US 2002/0169529 A1
(43) Pub. Date: Nov. 14, 2002

(54) Vehicle management system and method using mobile communication terminal

(76) Inventor: Kwang-Duck Kim, Bupyeong-ku (KR)

Correspondence Address: BAKER BOTTS L.L.P., 2001 ROSS AVENUE, SUITE 600, DALLAS, TX, 75201-2980, US

(21) Appl. No.: 09/997,964

(22) Filed: Nov. 29, 2001

(30) Foreign Application Priority Data
May 11, 2001 (KR) 10-2001-25951
Jun. 22, 2001 (KR) 10-2001-35966
Aug. 31, 2001 (KR) 10-2001-53638
Oct. 29, 2001 (KR) 20-2001-33082

(51) Int. Cl. G06F 19/00

(52) U.S. Cl. 701/33; 340/439

(57) ABSTRACT

Disclosed is a vehicle management system and method that uses a mobile communication terminal mounted in a vehicle capable of sensing and storing the driving and security information for the vehicle and sending the information stored therein to another party through the mobile communication terminal. The vehicle management system includes: a driving information sensing unit for sensing the driving speed, the driving distance, the sudden takeoff upon starting and the number of times of driving of the vehicle; a security information sensing unit for sensing the impacts applied from the outside to the vehicle and sound and image signals based on the impacts; a storing and outputting unit for storing the information of the vehicle sensed from the driving information sensing unit, the security information sensing unit, the telephone number of the vehicle information requester and for generating an alarm according to the sensed information of the vehicle; and a controller for sending, periodically or upon request of the vehicle information requester, the information of the vehicle stored in the storing and outputting unit to the vehicle information requester through the mobile communication terminal, on the basis of the information of the vehicle sensed from the driving information sensing unit and the security information sensing unit.

### BACKGROUND OF THE INVENTION

1. Field of the Invention

The present invention relates to a vehicle management system, and more particularly, to a vehicle management system and method that uses a mobile communication terminal mounted in a vehicle capable of sensing and storing the driving and security information for the vehicle and sending the information stored therein to another party through the mobile communication terminal.

2. Background of the Related Art

With the rapid development of the vehicle industry, the total number of vehicles on the road has increased dramatically. Although improving living conditions for the drivers of the vehicles, it is really difficult to control all the violations of traffic regulations committed by the drivers. Moreover, the increase in the number of vehicles is causing the rate of traffic accidents to rise drastically. To reduce the degree of damage caused by traffic accidents, the owners of the vehicles have had the vehicle insured compulsorily or optionally.

At present, large vehicles such as buses and trucks are provided with a tachometer mounted therein for measuring the driving speed, for the purpose of preventing traffic accidents and promoting safe driving. Installing tachometers is under the application of the law in force, but this may be have a negligible effect due to the non-existence of a system for managing and supervising the vehicles with tachometers mounted therein. As a result, this is generally under the supervision of transportation companies or vehicle owners.

However, transportation companies or vehicle owners aren't sensitive to the results of the driving speed recorded on the tachometer and in some cases, they support or look on the violations of traffic regulations for the purpose of pursuing their profits, such that objective management and supervision is actually absent. As a matter of fact, most transportation companies and vehicle owners don't have tachometers in their vehicles. Even when a tachometer is installed, it is not a strong enough motivator of safe driving because of the absence of objective management and supervision of the tachometer.

On the other hand, vehicle drivers have their vehicles insured compulsorily or optionally for unexpected accidents, and different insurance bills are calculated for the drivers of the vehicles insured, on the basis of the number of prior traffic accidents, the driving carrier and the age of each driver. Further, everyone receives different insurance money. In other words, the driver who has had many traffic accidents receives a small insurance and contrarily, the driver who has had less traffic accidents receives a large insurance.

However, it is difficult to apply reasonable insurance bills to every driver only with the standards mentioned above. For example, even though the drivers have the same driving carrier, they may have different driving times and distances. Therefore, in the case where two drivers don't have any prior traffic accidents, upon the calculation of the insurance bill additional points should be applied to the driver who has the substantially longer driving time and distance. Until now, however, since there is no method for obtaining such information on the driving of the drivers, it is difficult to calculate such reasonable insurance bills.

As the number of vehicles increases, the number of stolen cars increases year by year. To deal with this problem, there have been proposed various kinds of burglarproof devices. For example, one such device is designed to generate an alarm through a remote controller that has the functions of opening/closing the doors of the vehicle and starting it at a remote distance, in the case where the doors of the vehicle are opened by force by an intruder or an impact is applied to the vehicle.

In a conventional device, however, since the frequency used through the remote controller has a limited output and band, if the user is at a remote distance from the vehicle or if the user or vehicle is in a place such as an apartment complex or underground parking lot where the signal has difficulty reaching, the device cannot perform its burglarproof function. To solve the above problem, there is proposed a radio-controlled monitoring device using radio communication networks. However, since the radio-controlled monitoring device uses a radio LAN or a radio terminal having a bluetooth function, there occurs the problem of costly installation.

New models of mobile communication terminals are marketed year after year as mobile communication technologies develop. Consequently, the number of older models of mobile communication terminals is increasing rapidly, which results in an enormous loss of resources, and therefore, there arises a need for the recycling of these terminals.

### SUMMARY OF THE INVENTION

Accordingly, the present invention is directed to a vehicle management system and method, using a mobile communication terminal mounted in a vehicle, that substantially obviates one or more problems due to limitations and disadvantages of the related art.

An object of the present invention is to provide a vehicle management system and method that uses a mobile communication terminal mounted in a vehicle, which senses the driving information of the vehicle and sends the sensed driving information through mobile communication terminal to a vehicle information requester who desires to know the driving information of the vehicle.

Another object of the present invention is to provide a vehicle management system and method that uses a mobile communication terminal mounted in a vehicle, which senses the security information of the vehicle and sends the sensed security information through the mobile communication terminal to a vehicle information requester who desires to know the security information of the vehicle.

Yet another object of the present invention is to provide a vehicle management system and method that uses a mobile communication terminal mounted in a vehicle, which uses older models of mobile communication terminals as a means for sending the driving and security information of the vehicle to another party, thereby reducing the waste of resources and lowering manufacturing cost.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to an aspect of the present invention, there is provided a vehicle management system, using a mobile communication terminal mounted in a vehicle, which performs radio communication through the mobile communication terminal with a vehicle information requester who desires to know information on the vehicle, the system being comprised of: an interface unit for performing the radio communication with the mobile communication terminal; a driving information sensing unit for sensing the driving speed, the driving distance, the sudden takeoff upon starting and the number of times of driving of the vehicle; a security information sensing unit for sensing the impacts applied from the outside to the vehicle and sound and image signals based on the impacts; a storing and outputting unit for storing the information of the vehicle sensed from the driving information sensing unit and the security information sensing unit and the telephone number of the vehicle information requester and for generating an alarm according to the sensed information of the vehicle; and a controller for sending, periodically or upon request of the vehicle information requester, the information of the vehicle stored in the storing and outputting unit to the vehicle information requester through the mobile communication terminal, on the basis of the information of the vehicle sensed from the driving information sensing unit and the security information sensing unit.

According to another aspect of the present invention, there is provided a vehicle management method, using a mobile communication terminal mounted in a vehicle, which performs radio communication through the mobile communication terminal with a vehicle information requester who desires to know information on the vehicle, the method comprising the steps of: setting a reference value for determining whether the vehicle is at an abnormal state and the telephone number of the vehicle information requester; continuously sensing the state of the vehicle and storing the sensed information of the vehicle; continuously checking whether the sensed information of the vehicle exceeds the reference value; if the sensed information of the vehicle exceeds the reference value, informing the vehicle information requester of the abnormal state of the vehicle via a speaker and a display; and executing calling for the telephone number of the vehicle information requester to send the information of the vehicle sensed as the abnormal state.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a configuration of a vehicle management system using a mobile communication terminal according to the present invention;

FIG. 2 is a detailed block diagram for the system of FIG. 1;

FIG. 3 is a flowchart illustrating one embodiment of a vehicle management method using a mobile communication terminal according to the present invention; and

FIG. 4 is a flowchart illustrating another embodiment of a vehicle management method using a mobile communication terminal according to the present invention.

### DETAILED DESCRIPTION OF THE PREFERRED EMBODIMENTS

Reference will now be made in detail to the preferred embodiments of the present invention, examples of which are illustrated in the accompanying drawings.

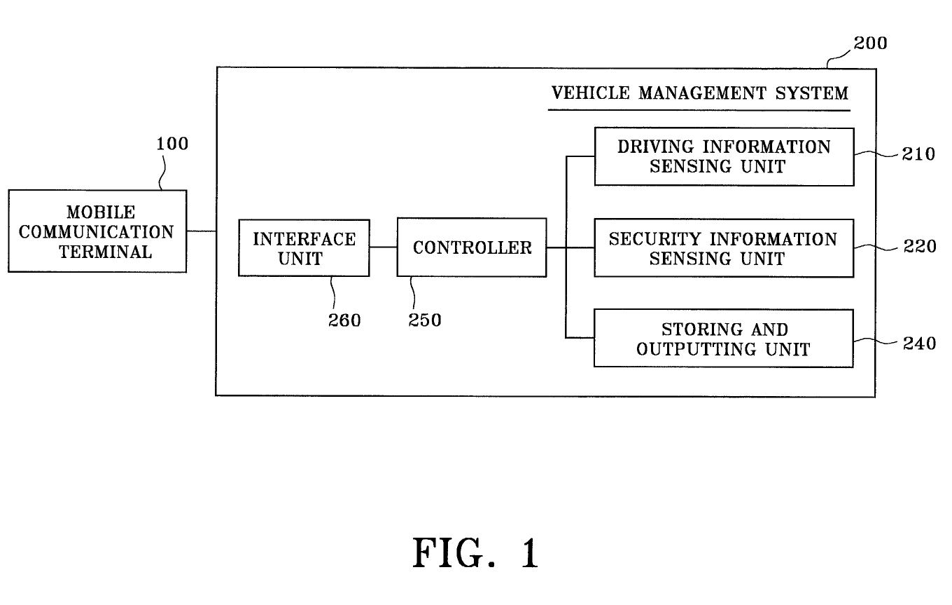

FIG. 1 is a block diagram illustrating a configuration of a vehicle management system using a mobile communication terminal according to the present invention.

According to the present invention, there is provided a vehicle management system 200, using a mobile communication terminal 100 mounted therein, which performs radio communication through the mobile communication terminal 100 with a vehicle information requester who desires to know information on the vehicle. The vehicle information requester is one or more of the following: a traffic regulation administrator, an insurance manager, the driver of the vehicle or a security company of the vehicle.

The vehicle management system 200 according to the present invention senses the information of the vehicle including the driving and security information thereof, stores the sensed information of the vehicle, and executes radio communication between the mobile communication terminal 100 and the vehicle information requester to send the desired information to the vehicle information requester in the case where the sensed driving or security information exceeds a prescribed reference value or upon request of the vehicle information requester.

Preferably, the mobile communication terminal 100 is embodied with older models of mobile communication terminals. The method for mounting the mobile communication terminal 100 in the vehicle is described below. Generally, the mobile communication terminal is provided with a microphone, a speaker, a keypad and an LCD as an unitary body therewith, but in the preferred embodiment of the present invention, the body thereof may be connected through a data line with its parts, wherein each of the parts is relocated for convenient use.

First, the body of the mobile communication terminal 100 may be secured under the seat of the driver for the purpose of preventing damage from external forces, and the microphone may be separated from the body of the mobile communication terminal 100 so as to be disposed at a position where the voice of the driver is clearly inputted, for example, over the driver's head. The speaker may be separated from the body of the mobile communication terminal 100 so as to be disposed at a position where the emitted sound therefrom is clearly audible. Since all mobile communication terminals have a connecting terminal through which the speaker and mike are connected, the speaker and microphone are extended through the connecting terminal and separated from the body of the mobile communication terminal 100.

The keypad may be separated from the body of the mobile communication terminal 100 so in order to be accessible, at a position within the range of the manipulation of the driver, for example, between the driver seat and the front passenger seat, on the panel with the car stereo mounted thereon or around the panel. Since the display is difficult to separate from the body of the mobile communication terminal 100, it may be attached to the keypad or mounted on an additional pad, if necessary.

The parts of the body of the mobile communication terminal 100 are individually separated from each other, but they may be separated integrally by an additional multipoint device with the connecting terminal provided in the mobile communication terminal 100, so that they can be mounted at their convenient positions.

On the other hand, the vehicle management system 200 is comprised of: an interface unit 260 for performing radio communication with the mobile communication terminal 100; a driving information sensing unit 210 for sensing the driving speed, the driving distance, the sudden takeoff upon starting and the number of times of driving of the vehicle monitored by a controller 250; a security information sensing unit 220 for sensing the impact applied from the outside to the vehicle and sound and image signals based on the impact monitored by the controller 250; and a storing and outputting unit 240 for storing the information of the vehicle sensed from the driving information sensing unit 210 and the security information sensing unit 220 and for transmitting the sensed information to requester and for generating an alarm on the basis of the sensed information of the vehicle monitored by the controller 250.

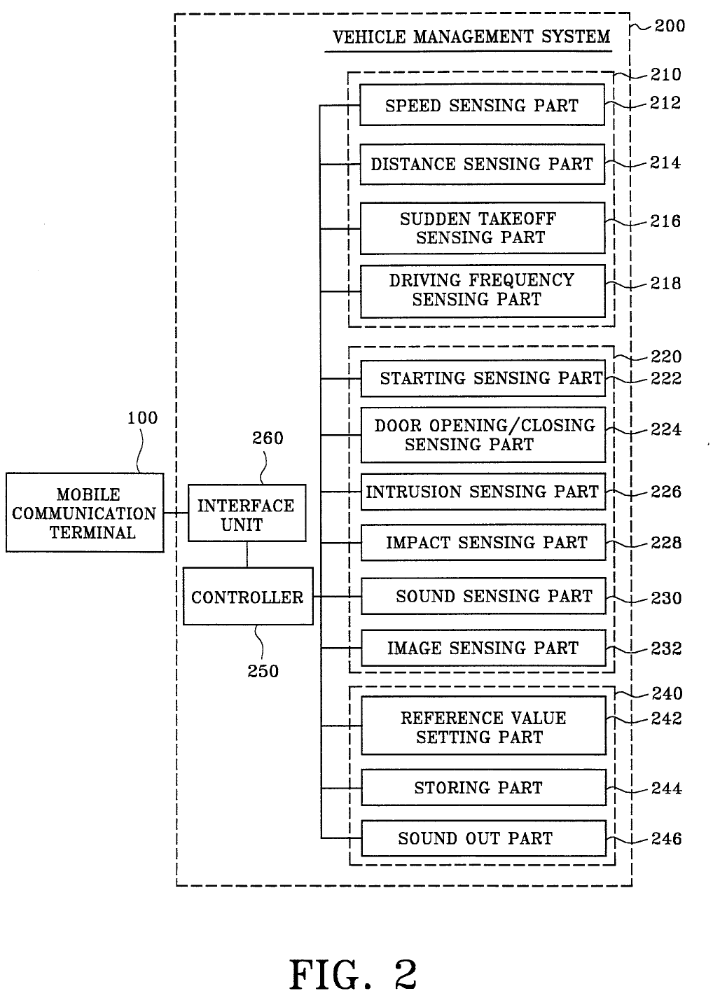

FIG. 2 is a detailed block diagram for the system of FIG. 1.

As shown, the vehicle management system 200 is provided with the driving information sensing unit 210, the security information sensing unit 220, the storing and outputting unit 240, the controller 250 and the interface unit 260. The driving information sensing unit 210 includes a speed sensing part 212, a distance sensing part 214, a sudden takeoff sensing part 216 and a driving frequency sensing part 218, and the security information sensing unit 220 includes a starting sensing part 222, a door opening/closing sensing part 224, an intrusion sensing part 226, an impact sensing part 228, a sound sensing part 230 and an image sensing part 232.

The driving information sensing unit 210 is configured in the manners that will be discussed below. The speed sensing part 212 is attached to each of the locations where the driving speed of the vehicle can be sensed, for example, on the side, front and lower surfaces of the vehicle. The speed sensing part 212 may be embodied as, for example, a tachometer. A reference value, which is used to determine a violation of the speed limit, is set by a reference value setting part 242, and if the state of the violation of the speed limit is sensed by means of the speed sensing part 212, the controller 250 stores the information of the violation comprised of the speed and time of the violation in a storing part 244.

The information of the violation of the speed limit stored in the storing part 244 is sent to the vehicle information requester, at the time of the violation or periodically or upon the request of the vehicle information requester, through the mobile communication terminal 100. In that case, the vehicle information requester who desires to know the information of the violation of speed may be a traffic regulation administrator (system). The traffic regulation administrator continuously receives the information on the speed limit violations of each vehicle and assesses a reasonable fine for the driver. Thus, the driver tries to avoid speeding, which can help prevent traffic accidents.

The distance sensing part 214 senses the driving distance by periods of the vehicle to store the sensed information in the storing part 244. The distance sensing part 214 may be embodied with one of devices for calculating the driving distance of the vehicle, for example, a tachometer. The sudden takeoff sensing part 216 senses whether the sudden takeoff exists upon starting the vehicle and stores the sensed information in the storing part 244. The driving frequency sensing part 218 senses the number of times the vehicle is driving, each starting stored as sensed information in the storing part 244. Each of the distance sensing part 214, the sudden takeoff sensing part 216 and the driving frequency sensing part 218 each may be embodied with a senor or a tachometer and are attached or mounted on each part of the interior of the vehicle.

The information of the driving distance, the sudden takeoff upon starting and the number of times of driving stored in the storing part 244, with the information of speed limit violations, are sent to the vehicle information requester, at the time of the violation or periodically or upon request of the vehicle information requester, through the mobile communication terminal 100. In that case, the vehicle information requester who desires to know the information of the driving distance, the sudden takeoff upon starting and the number of times of driving may be an insurance manager (system). So, the insurance manager receives the driving information of each vehicle and calculates a reasonable insurance for each driver.

Next, the security information sensing unit 220 is configured in the manners as will be discussed below. In the preferred embodiment of the present invention, the vehicle management system can execute radio communication with the radio terminal of the driver and/or the radio alarm device of the vehicle security company.

The starting sensing part 222 is connected to the starter of the vehicle and starts the vehicle in the case where a starting command is transmitted from the radio terminal of the driver of the vehicle through the mobile communication terminal 100. The door opening/closing sensing part 224 is connected to the door opening/closing device of the vehicle and opens and closes the doors of the vehicle in the case where a door opening/closing command is transmitted from the radio terminal of the driver of the vehicle through the mobile communication terminal 100.

In that case, so as to control the vehicle with the radio terminal of the driver of the vehicle, a communication channel is set between the radio terminal and the mobile communication terminal 100 and then, the process of setting the manipulation of the radio terminal is carried out.

The intrusion sensing part 226 is adapted to sense whether the doors of the vehicle are opened by an undesirable force, and if an entry into the vehicle without permission is sensed, the intrusion sensing part 226 informs the controller 250 of the intrusion, such that a warning message is generated from the controller 250 without any delay. The impact sensing part 228 is adapted to sense the impact applied to the vehicle and compare the amount of impact applied to the vehicle with the amount of impact set in the reference value setting part 242, and if the impact applied is over a predetermined reference value, the impact sensing part 228 informs the controller 250 of the impact, such that a warning message is generated from the controller 250 without any delay.

When an intrusion or an impact over the predetermined reference value is sensed, the controller 250 controls the mobile communication terminal 100 and calls a prescribed telephone number (of the driver of the vehicle and/or of the security company for the vehicle) to thereby generate an alarm. At the same time, the controller 250 controls a sound output part 246 that generates an alarm through the speaker connected to the mobile communication terminal.

The sound sensing part 230 senses the voice of the intruder or the sound generated by the intrusion and stores the sensed information in the storing part 244. The image sensing part inputs the image of the intruder and stores the inputted image to the storing part 244.

If the doors of the vehicle are opened and closed by force or if the impact over a predetermined limit is applied to the vehicle, the information of the intrusion is sent on real time to the driver of the vehicle and/or the security company of the vehicle, thereby preventing the theft of the vehicle. To send such information of the intrusion, the telephone numbers of the driver of the vehicle and/or the security company of the vehicle are stored in the storing part 244. And, the information of the voice and image of the intruder stored in the storing part 244 is sent to the vehicle information requester through the mobile communication terminal 100, upon request of the vehicle information requester. In that case, the vehicle information requester who desires to know the vehicle security information on the door opening/closing, the intrusion, the application of the impact and the voice and image of the intruder may be the driver (radio terminal) of the vehicle and/or the security company (system) of the vehicle. At that time, the driver (radio terminal) of the vehicle and/or the security company (system) of the vehicle continuously receive the security information of the vehicle to thereby prevent the vehicle from being stolen.

In the preferred embodiment of the present invention, the security information sensing unit 220 further includes a driver calling sensing part (which is not shown in the drawing) that generates a calling signal to the radio terminal of the driver through a driver calling means attached on a predetermined portion of the vehicle, in the case where urgent radio communication with the driver of the vehicle is required at the time when problems related to parking and stopping are generated.

The vehicle management system of the present invention is used for managing vehicles, but may be applied to a sensing device using the mobile communication terminal. In other words, the measuring value sensed by the sensing device is sent to a predetermined departure through the mobile communication terminal. In that case, the present invention is further provided with a sensor for sensing an amount of power consumption or a degree of water pollution to thereby provide the measured value through the mobile communication terminal.

In that case, the amount of power consumed may be determined by the distance sensing part and the degree of water pollution may be determined by the speed sensing part.

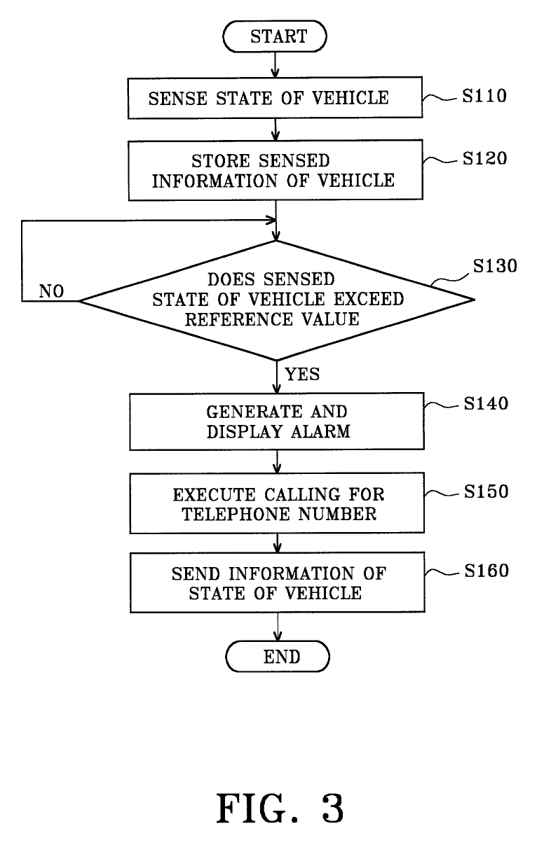

FIG. 3 is a flowchart illustrating an embodiment of a vehicle management method by using the mobile communication terminal according to the present invention, wherein at the time when some value of the state of vehicle sensed exceeds the prescribed reference value the vehicle information is sent to the vehicle information requester.

The mobile communication terminal is mounted in the vehicle to which the principles of the present invention is applied and also connected with the vehicle management system of the present invention that senses various states of the vehicle and stores the sensed information therein. Furthermore, the mobile communication terminal has radio communication with the vehicle information requester. Additionally, the reference value for determining whether or not the state of vehicle sensed in the vehicle management system is abnormal and the telephone number of the vehicle information requester to be called for sending the abnormal state of the vehicle are all set.

First, the vehicle management system continuously senses vehicle information (at step S110) and stores the sensed vehicle information (at step S120). The vehicle information is comprised of vehicle driving information and vehicle security information. The vehicle driving information contains the driving speed of the vehicle, the driving distance in periods of the vehicle, the sudden takeoff of the vehicle upon starting and the number of times of driving of the vehicle, and the vehicle security information contains the door opening/closing by force of the vehicle, intrusions into the vehicle, impacts applied from the outside to the vehicle and the voice and image signals of the intruder.

Then, it is checked whether or not the sensed vehicle information exceeds the prescribed reference value (at step S130), and if the sensed vehicle information exceeds the prescribed reference value, the abnormal state is sent in the form of an alarm or on the screen through the speaker or the display (at step S140). Further, calling the telephone number of the vehicle information requester is executed (at step S150), such that the vehicle information sensed as the abnormal state is sent to the vehicle information requester through the mobile communication terminal.

For example, in case the driving speed of the vehicle exceeds the prescribed reference value, the speeding is made known to the traffic regulation administrator for the assessment of a fine thereof. In case the doors of the vehicle are opened and closed by force, in case an impact applied from the outside exceeds the prescribed reference value, or in case an intrusion to the vehicle occurs, the vehicle burglar warning contents are made known to the driver of the vehicle or the security company of the vehicle, thereby preventing the theft of the vehicle.

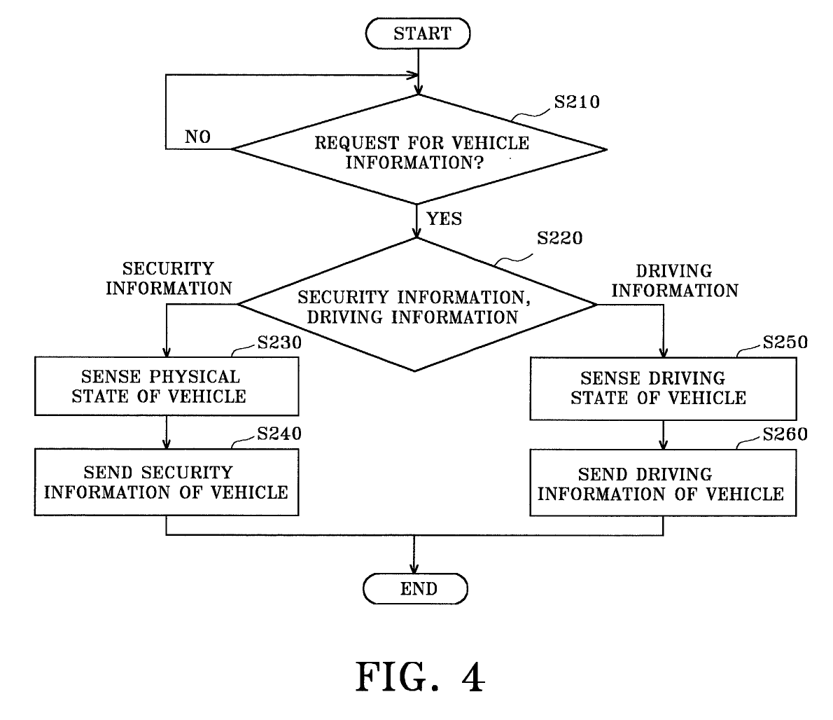

FIG. 4 is a flowchart illustrating another embodiment of the vehicle management method by using the mobile communication terminal according to the present invention, wherein upon request of the vehicle information requester, the sensed vehicle information stored is sent to the vehicle information requester.

The mobile communication terminal is mounted in the vehicle to which the principles of the present invention is applied and also connected with the vehicle management system of the present invention that senses various states of the vehicle and stores the sensed information therein. The vehicle information requester is one or more of the following: a traffic regulation administrator, an insurance manager, the driver of the vehicle or a security company of the vehicle.

First, the vehicle management system continuously senses whether or not the vehicle information is requested by the vehicle information requester (at step S210) and if a vehicle information request is made, checks whether the vehicle information requested corresponds to the security information or the driving information (at step S220).

If it is checked that the vehicle information requested corresponds to the security information, the vehicle management system senses the physical state of the vehicle (at step S230). The physical state of the vehicle includes the door opening/closing by force, intrusions into the vehicle, impacts applied from the outside and the voice and image signals of the intruder. After that, the sensed vehicle security information is sent to the vehicle information requester through the mobile communication terminal (at step S240). In this case, the vehicle information requester may be the driver of the vehicle and/or the security company of the vehicle.

On the other hand, if it is checked that the vehicle information requested corresponds to the driving information, the vehicle management system senses the driving state of the vehicle (at step S250). The vehicle driving information includes the driving speed of the vehicle, the driving distance in periods of the vehicle, the sudden takeoff of the vehicle upon starting and the number of times of driving of the vehicle. After that, the sensed vehicle driving information is sent to the vehicle information requester through the mobile communication terminal (at step S260). In this case, the vehicle information requester may be the traffic regulation administrator or the insurance manager or both.

As set forth in the foregoing, a vehicle management system using a mobile communication terminal according to the present invention is capable of continuously sensing and storing the driving information of the vehicle and in the case where the sensed driving information exceeds a prescribed reference value or upon request of a vehicle information requester, sending the stored information through the mobile communication terminal. In the case of a violation of traffic regulations, reasonable and real-time management and supervision thereof is carried out. As traffic accidents are prevented the life of the vehicle is prolonged, thereby improving safety and economic gains. Additionally, insurances are calculated differently every driver, based upon the vehicle driving information, such that it is advantageous for good drivers, which promotes safe driving.

Moreover, the vehicle management system using the mobile communication terminal according to the present invention is capable of continuously sensing and storing the security information of the vehicle and in the case where the sensed security information exceeds a prescribed reference value, sending the stored information to the vehicle information requester, whereby the attempted burglary of the vehicle is instantly recognized and prevented. At that time, the voice and image of the intruder are stored, which can be helpful in tracking down the intruder of the vehicle.

Furthermore, older models of mobile communication terminals are used as a means for sending the vehicle driving information and the vehicle security information, which ensures effective recycling of resources.

The forgoing embodiments are merely exemplary and are not to be construed as limiting the present invention. The present teachings can be readily applied to other types of devices. The description of the present invention is intended to be illustrative, and not to limit the scope of the claims. Many alternatives, modifications, and variations will be apparent to those skilled in the art.

What is claimed is:

1. A vehicle management system, using a mobile communication terminal mounted in a vehicle, which performs radio communication through said mobile communication terminal with a vehicle information requester who desires to know information on the vehicle, said system being comprised of:
an interface unit for performing the radio communication with said mobile communication terminal;
a driving information sensing unit for sensing the driving speed, the driving distance, the sudden takeoff upon starting and the number of times of driving of the vehicle;
a security information sensing unit for sensing the impact applied from the outside to the vehicle and sound and image signals based on the impact;
a storing and outputting unit for storing the information of the vehicle sensed from said driving information sensing unit and said security information sensing unit and the telephone number of said vehicle information requester and for generating an alarm according to the sensed information of the vehicle; and
a controller for sending, periodically or upon request of said vehicle information requester, the information of the vehicle stored in said storing and outputting unit to said vehicle information requester through said mobile communication terminal, on the basis of the information of the vehicle sensed from said driving information sensing unit and said security information sensing unit.

2. The system as defined in claim 1, wherein said vehicle information requester comprises at least one of a traffic regulation administrator, an insurance manager, the driver of the vehicle and a security company of the vehicle.

3. The system as defined in claim 1, wherein said driving information sensing unit comprises:
a speed sensing part for sensing the driving speed of the vehicle and storing the sensed result;
a distance sensing part for sensing the driving distance by periods of the vehicle and storing the sensed result;
a sudden takeoff sensing part for sensing whether sudden takeoff occurs upon starting of the vehicle and storing the sensed result; and
a driving frequency sensing part for sensing the number of times of driving of the vehicle and storing the sensed result.

4. The system as defined in claim 3, wherein said speed sensing part comprises a sensor for sensing water pollution.

5. The system as defined in claim 3, wherein said distance sensing part comprises a sensor for sensing an amount of power consumption.

6. The system as defined in claim 1, wherein said security information sensing unit comprises:
an intrusion sensing part for sensing whether or not the doors of the vehicle are opened and closed by force and if an entry to the vehicle without permission is sensed, generating an alarm on the basis of the sensed result;
an impact sensing part for sensing the impact applied to the vehicle to compare the sensed impact with a prescribed impact value and if the impact applied to the vehicle is over the prescribed impact value, generating an alarming message;
a sound sensing part for sensing the voice of an intruder to the vehicle after the intrusion to the vehicle has been generated and storing the sensed voice; and
an image sensing part for sensing the image of the intruder to the vehicle after the intrusion to the vehicle has been generated and storing the sensed image.

7. The system as defined in claim 6, wherein said security information sensing unit further comprises a driver calling sensing part for generating a calling signal for the driver of the vehicle, in the case where urgent radio communication with the driver of the vehicle is required.

8. A vehicle management method, using a mobile communication terminal mounted in a vehicle, which performs radio communication through the mobile communication terminal with a vehicle information requester who desires to know information on the vehicle, said method comprising the steps of:
setting a reference value for determining whether or not the vehicle is at an abnormal state and the telephone number of said vehicle information requester;
continuously sensing the state of the vehicle and storing the sensed information of the vehicle;
continuously checking whether the sensed information of the vehicle exceeds said reference value;
if the sensed information of the vehicle exceeds said reference value, informing said vehicle information requester of the abnormal state of the vehicle via a speaker and a display; and
calling the telephone number of said vehicle information requester to send the information of the vehicle sensed as the abnormal state.

9. The method as defined in claim 8, wherein said vehicle information is comprised of vehicle driving information and vehicle security information, said vehicle driving information contains the driving speed of the vehicle, the driving distance in periods of the vehicle, the sudden takeoff of the vehicle upon starting and the number of times of driving of the vehicle, and said vehicle security information includes the door opening/closing by force of the vehicle, intrusions into the vehicle, impacts applied from the outside and the voice and image signals of the intruder.

10. The method as defined in claim 8, wherein said vehicle information requester comprises at least one of a traffic regulation administrator, an insurance manager, the driver of the vehicle and a security company of the vehicle.

11. A vehicle management method, using a mobile communication terminal mounted in a vehicle, which performs radio communication through the mobile communication terminal with a vehicle information requester who desires to know information on the vehicle, said method comprising the steps of:
continuously sensing whether vehicle information is requested by said vehicle information requester;
if the vehicle information request is inputted, checking whether the vehicle information requested corresponds to security information or driving information;
if it is checked that the vehicle information requested corresponds to said security information, sensing the physical state of the vehicle;
sending the sensed vehicle security information to said vehicle information requester through said mobile communication terminal;
if it is checked that the vehicle information requested corresponds to said driving information, sensing the driving state of the vehicle; and
sending the sensed vehicle driving information to said vehicle information requester through said mobile communication terminal.

12. The method as defined in claim 11, wherein said vehicle information is comprised of vehicle driving information and vehicle security information, said vehicle driving information contains the driving speed of the vehicle, the driving distance in periods of the vehicle, the sudden takeoff of the vehicle upon starting and the number of times of driving of the vehicle, and said vehicle security information includes the door opening/closing by force of the vehicle, intrusions into the vehicle, impacts applied from the outside and the voice and image signals of the intruder.

13. The method as defined in claim 8, wherein said vehicle information requester comprises at least one of a traffic regulation administrator, an insurance manager, the driver of the vehicle and a security company of the vehicle.
